(19) United States
(12) Patent Application Publication
(10) Pub. No.: US 2021/0232104 A1
(43) Pub. Date: Jul. 29, 2021

(54) METHOD AND SYSTEM FOR IDENTIFYING AND FORECASTING THE DEVELOPMENT OF FAULTS IN EQUIPMENT

(71) Applicant: JOINT STOCK COMPANY "ROTEC", Moscow (RU)

(72) Inventors: Sergey Andreevich NAUMOV, Lytkarino (RU); Alexandr Vasilievich KRYMSKY, Moscow (RU); Mikhail Valerievich LIFSHITS, Moscow (RU)

(21) Appl. No.: 17/050,633

(22) PCT Filed: Apr. 26, 2019
(86) PCT No.: PCT/RU2019/050053

§ 371 Date: Oct. 26, 2020

(30) Foreign Application Priority Data
Apr. 27, 2018 (RU) 2018115925

(51) Int. Cl. G05B 13/04; G05B 13/02

(52) U.S. Cl. CPC G05B 13/042; G05B 13/048; G05B 13/027

(57) ABSTRACT

The invention relates to the remote monitoring of equipment. In a method for identifying incipient faults in technical equipment, data is obtained about the equipment being monitored; a reference sample of performance indices of the equipment is generated; state matrices and empirical state forecasting models are constructed. Disruptions and integral criteria characterizing deviations in the parameter indices of the equipment being monitored are also determined; information from the equipment being monitored is analyzed; the reference sample is modified; the empirical models are updated. The degree to which the parameter indices of the equipment being monitored deviate from the indices of the empirical models is also determined, and disruptions pertaining to such indices are identified. The calculated disruptions are then ranked; an anomaly for a performance index of the equipment is determined; the type of fault is determined for each anomaly; an equipment fault classifier is generated and an incipient fault is determined and the development thereof is forecast. Automated fault determination is hereby provided.

### FIELD OF THE INVENTION

The invention relates to a prognostics and remote monitoring system (hereinafter referred to as the P&RMS), artificial intelligence system, and the method used therein for automatically identifying and predicting development of incipient defects in process units related to equipment thereof.

### BACKGROUND

An artificial intelligence based personalized neural network search method is known (patent CN 106354856, BEIJING BAIDU NETCOM SCI & TEC, Jan. 25, 2017). The method comprises the steps of: sending search request from a terminal, the request containing a search item and implicit data; importing the search item into a step where the results are matched against the search item and the primary similarities between the results and the search item are determined; importing the search results and the implicit search item determined in accordance with the implicit search data into a pre-trained model of implicit matching and determining a secondary similarity between the search results and the implicit search results; ordering the search results against the primary similarity and the second similarity, generating thereby the search results display order, and sending the search results and the display order to the terminal, so that the terminal displays the search results according to the display order, which can improve the search accuracy. Disadvantages of this solution consist in absence of automated diagnostics and prognostics based on reference samples of parameters.

A sintering machine predictive control method using an artificial neural network is known (WO 2008031177, GERDAU ACOMINAS SA, Mar. 20, 2008). The method is based on training a neural network using fragments of process information. This training proceeds in real time using a special software, which allows to correct prognoses and ensures operational stability.

Disadvantage of this solution is the real time prognostics regardless of the previously obtained data, which does not allow to quickly and accurately reveal a possible future malfunction of the unit.

A system and method for monitoring an industrial process are known (U.S. Ser. No. 08/255,586, ARCH DEVELOPMENT CORPORATION, Dec. 17, 1996). These system and method include a plurality of sensors that monitor industrial process parameters, a plurality of devices that convert perceived data into computer-compatible information, and a computer that runs a computer software to analyze the sensor data and detect statistically reliable alarm conditions. The computer software removes sequential correlation information and then builds the data distribution to calculate the probability factor needed to detect alarm condition.

A method and system for monitoring transient signals of an industrial device for determining its operating state are known (U.S. Ser. No. 08/521,892, ARCH DEVELOPMENT CORPORATION, Apr. 28, 1998), which comprises steps of reading training data from memory and determining neural network weighting values until achieving target outputs close to the neural network output. If the target outputs are inadequate, parameters are determined such as to yield neural network outputs close to the desired set of target outputs. Then the system provides signals characteristic of an industrial process and

compares the neural network output with the industrial process signals to evaluate the operating state of the industrial process.

Disadvantage of this solution is inability to automatically identify an incipient defect and predict its development.

The closest prior art to this invention is a remote monitoring and diagnostics system (RM&DS) (patent RU 2626780, Joint Stock Company “ROTEK”, Aug. 1, 2016) designed for automated detection of process abnormalities (changes in technical state caused by deviations of a group of arguments or parameters from reference values ranked by assigned weights).

A transparent and mathematically sound algorithm based on MSET (Multivariate State Estimation Technique), which is used in RM&DS, analyzes input data for presence of deviations from model due to exceeding a threshold level of the Hotelling's criterion (T²), and, if detected, allows to identify the parameters that caused the deviation. Said statistical criterion T², being a quadratic form of the standardized residuals, is optimal for evaluating technical systems. FIG. 1 shows distribution of standardized GTU (Gas Turbine Unit) parameter residuals, which is very close to normal distribution. Here 1 denotes the normal distribution, 2 denotes residuals with RMS correction, and

3 denotes residuals adjusted for mean and RMS.

Results of RM&DS calculations are automatically interpreted by expert modules to accurately yield defect occurrence causes and locations. RM&DS automatically and with high efficiency detects changes in technical state of units, but cannot automatically determine the cause (i.e. cannot localize the defect). Besides, RM&DS allows to predict the unit's technical state change trend.

Disadvantage of this solution is inability to automatically identify an incipient defect and predict its development.

### DISCLOSURE OF THE INVENTION

The aim of this invention is to create a system for predicting development and remotely identifying of incipient defects (SPD&RI) and a method for classifying defects in process units (hereinafter referred to as the test units or test unit components) implemented in the system, which allows to detect changes in technical state of process units at early stage and predict future malfunctions of these units and/or their parts with automatic identification of each incipient defect.

The object of this invention is to create an artificial intelligence based SPD&RI, which provides automatic determination of incipient defect occurrence cause and location in any operating mode of remotely tested units by detecting and recognizing the occurrence of process abnormalities.

To solve the problem of detecting process abnormalities, it is possible to use other nonparametric modeling methods in addition to MSET, for example, kernel regression with kernel smoothing, Support Vector Machine (SVM), fuzzy logic methods, boosting decision trees, principal components, neural networks, and, finally, Similarity Based Modeling (SBM) methods. Results of said additional methods of nonparametric modeling can be verified in the on-line mode against the MSET method results obtained in the off-line mode.

All methods of nonparametric modeling are used to determine process abnormalities in the operable technical state of units, while incipient defects can be identified only using a neural network.

The main disadvantage of currently existing artificial intelligence systems and deep neural networks is considered to be their inability to independently master new skills. In order to teach them how to perform a new task, it is necessary to use bulk data manually processed by human operator. In contrast, SPD&RI generates its own base of significant process abnormalities for training the neural network, the human operator adding only a comment identifying the defect.

In one preferred embodiment of the claimed invention, a method for identifying incipient defects in process units is presented, which consists in performing steps of:
receiving data from the test unit that characterize operating parameters of said unit;
forming a reference sample of received unit operating parameters, the said sample corresponding to a continuous operation time interval of the test unit;
building up a state matrix of reference sample parameter values;
building up at least one empirical model for predicting state of the test unit, which represents the unit's state in a multidimensional space of unit parameters;
defining integral criteria that characterize deviations of the test unit's parameters;
determining imbalances that reflect degree of unit operating parameters influence on said deviations of the test unit operating parameters;
analyzing the input information from the test unit using the obtained set of empirical models by comparing the received test unit parameters with the model parameters within a given time interval;
modifying the reference sample by replenishing it with points collected within the new time period and filtering points corresponding to the mode of operation described by the model and corresponding to a new functional state of the test unit;
updating pre-built empirical models based on the filtered sample;
determining degree of input test unit parameters deviation from parameters of empirical models for a given period of time based on said integral criteria and revealing imbalances for these parameters;
sorting calculated imbalances to determine upper imbalances, which represent the parameters that most strongly contribute to the test unit state change;
identifying at least one significant process abnormality in at least one test unit parameter based on certain integral criteria and upper imbalances;
identifying type of defect in the test unit for each significant process abnormality;
compiling a digital classifier of defects in the unit based on identified significant process abnormalities, containing identified parameters of process abnormalities in various operating modes of the test unit;
identifying at least one incipient defect is determined and predicting its development by means of processing input information from the test unit by a neural network trained on the generated digital classifiers.

In one particular embodiment of the invention, empirical models are created using a method selected from the group comprising: MSET (Multivariate State Estimation Technique), Kernel Regression, Kernel Smoothing, Support Vector Machine (SVM), Similarity Based Modeling (SBM), neural networks, fuzzy logic, principal components, or boosting decision trees.

In still another particular embodiment of the invention, empirical models are statistical and dynamic models.

In still another particular embodiment of the invention, empirical models are created for a plurality of different modes of test unit operation.

In still another particular embodiment of the invention, an empirical model corresponding to a given mode of test unit operation is automatically switched into another model corresponding to new mode of test unit operation when the mode of operation is changed.

In still another particular embodiment of the invention, training samples of significant process abnormalities are generated for a neural network by the prognostics and remote monitoring system itself.

In still another particular embodiment of the invention, a digital classifier of defects is a set of pairs of significant process abnormalities data and descriptions of corresponding defects.

In still another particular embodiment of the invention, significant process abnormalities are determined in on-line mode using nonparametric modeling methods.

In still another particular embodiment of the invention, the integral criterion is selected from the group consisting of Hotelling's criterion, Kremer's criterion, and Wilcoxon's criterion.

In another preferred embodiment of the claimed invention, a system for identifying incipient defects in process units is provided, comprising at least one processor and memory means that contain machine-readable instructions, which implement above mentioned method for identifying incipient defects in process units if being executed by said processor,

In one particular embodiment of the invention, the system contains at least one personal workstation designed to receive the notification on identification of an incipient defect in a test unit and/or its component.

In one particular embodiment of the invention, the notification additionally contains information about residual resource of the test unit and/or its component.

In one particular embodiment of the invention, the personal workstation is selected from the group comprising a personal computer, laptop, tablet, smartphone, or thin client.

In one particular embodiment of the invention, the notification is transmitted via wired and/or wireless communication means.

In one particular embodiment of the invention, the notification is sent to the corresponding personal workstation depending on type of defect.

### BRIEF DESCRIPTION OF DRAWINGS

FIG. 1 illustrates distribution of standardized GTU parameter residuals.

FIG. 2 illustrates architecture of SPD&RI FIG. 3 shows main steps of the claimed method.

FIGS. 4 and 5 illustrate an example of graphical user interface in SPD&RI.

FIG. 6 shows flowchart of steps to be performed for predictive modeling.

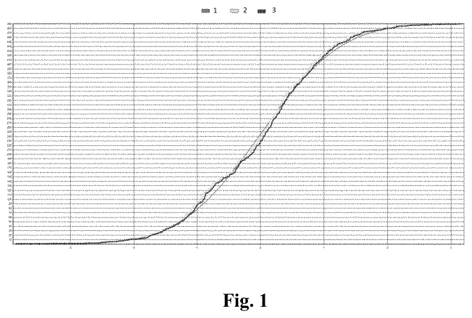

### EMBODIMENTS OF THE INVENTION

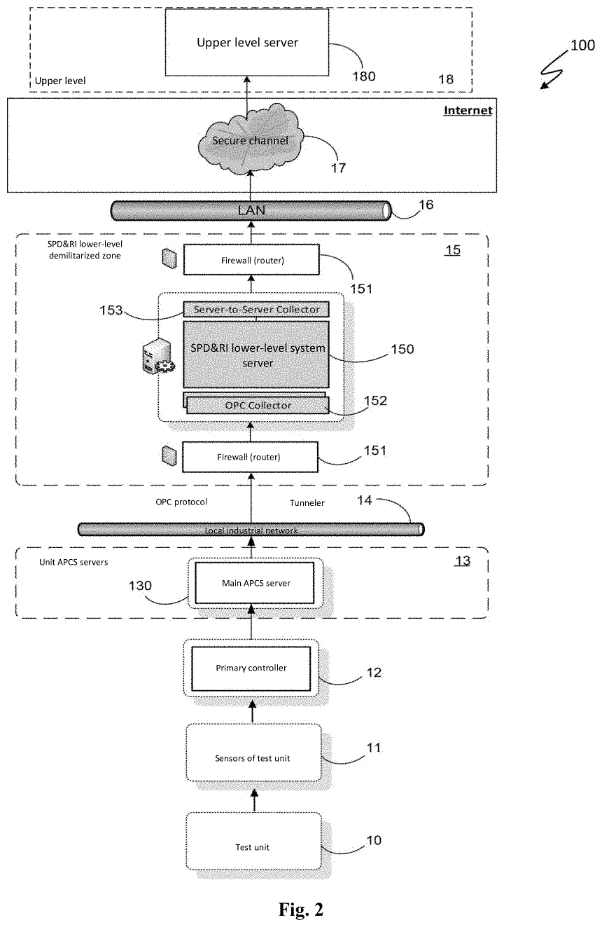

FIG. 2 shows overall architecture of the claimed solution, in particular, SPD&RI (100). SPD&RI (100) consists of lower-level (15) and upper-level (18) subsystems. Both levels are implemented in servers (150) and (180) that perform special functions. The lower-level server (150) is designed to collect, primarily process, buffer, and transmit data to the upper-level server (180), which is designed to solve analytical problems associated with monitoring and predicting states of test process units (10).

The test units may include various facilities such as, for example, power generating equipment (turbine units, various power installations, reactors, etc.); process monitoring equipment (conveyors, robotic units), heating equipment (boilers, pumps, etc.).

The test units may also include vehicles, for example, cars, rail transport, airplanes, etc.

Data collecting and transmitting process is implemented on the basis of two-server scheme. Data collection begins at the lower level of test unit (10) monitoring, where values of operational parameters such as, for example, temperature, vibration, wear rate, rotation speed, current, voltage, frequency, etc., are measured by sensors (11) mounted on the test unit (10) and recorded. The readings from sensors constituting a group of sensors (11) are sent to primary controllers (12), which redirect them to the main server of automated process control system (APCS) (130).

Server of the lower-level subsystem (150) of SPD&RI (100) may be installed in a separate cabinet located in a specialized server room, in the immediate vicinity of the existing APCS servers (13) of the unit. Collected data are further transmitted out of a local industrial network (14) formed by one or several APCS servers (130) to SPD&RI lower-level server (150). Data can be transmitted to the lower-level server (150) using OPC (OLE for Process Control) protocol and OPC tunneling hardware (152).

SPD&RI lower-level zone (15) can be designed as a demilitarized zone with firewalls (151), which receive data from the APCS server (130) and transfer them to upper-level zone (18) through a data commutator (153) between servers. Such design allows to isolate operation of the unit APCS (130) from the lower-level system (15) and also ensures safety of the received data in the event of emergency situations.

Data received from sensors (11) of the test unit (10) in the form of process parameters are transferred to a unified archive of the SPD&RI upper-level server (180). The data are transmitted to the upper-level server (180) via a LAN (16), for example, via the global network (Internet). To transfer this information, a secure data transmission channel (17) of the LAN (16) can be used, which provides data transmission in real time without loss of quality using a lower-level (15) and upper-level (18) servers (150, 180) synchronization procedure. In addition, full data availability at the upper-level server (180) provides the possibility to thoroughly analyze technical state of the unit by specialists working with the upper-level system (18), which facilitates monitoring of the technical state of all units (10) by these specialists.

The upper-level server (180) is configured for automatic on-line analytical data processing by means of empirical modeling. Empirical models are constructed using statistical methods based on a sample of the values of the unit process parameters for the period of operation taken as a reference.

FIG. 3 illustrates the method (200), which is implemented on the said upper-level server (180) to monitor and analyze technical state of the test unit (10).

At the step (201), upper-level server (180) receives data representing process state parameters of test unit (10) according to readings obtained from sensors (11).

At the step (202), a reference sample of test unit (10) parameters consisting of values of said process state parameters of the test unit (10) is formed from received parameters of the test unit (10). Each of these parameters corresponds to a sampling point that reflects values of one or more indicators of technical state of the unit (10) over a time interval of continuous operation.

Next, at the step (203), a state matrix is constructed from the sampling points of the reference sample, with the components being the values of said process state parameters of the test unit (10).

Then, at the step (204), empirical models are constructed for predicting the test unit state, each of models reflecting the unit state in the multidimensional space of the unit (10) parameters and thereby simulates its overall state. Empirical models for predicting the test unit (10) state are constructed using statistical methods based on a sample of the values of the unit (10) process parameters over the period of operation taken as a reference.

To build empirical models, various methods and approaches can be used, for example, MSET (Multivariate State Estimation Technique), Kernel Regression, Kernel Smoothing, Support Vector Machine (SVM), Similarity Based Modeling (SBM), neural networks, fuzzy logic algorithm, main components, tree boosting, etc.

Several models can be created for one test unit (10), each corresponding to a certain mode of its operation. Behavior of test unit (10) in different operating modes can differ significantly; therefore, to simulate its performance, it is necessary to use a number of models corresponding to different operating modes. Switching between operating mode models is carried out automatically during on-line modeling at changing operating mode of the test unit (10).

At the step (205), integral criteria are defined that characterize deviations of the test unit parameters.

Integral criteria are defined based on the problem to be solved and are calculated using known formulas.

In particular, Hotelling's T² test, which may be considered as a generalization of the Student's test to a multidimensional case or a quadratic form of normalized residuals, can be used for this purpose. Let \vec{N} denotes column of normalized residuals. To assess deviation from a reference, it is necessary to calculate the value

T²=(\vec{N}− [symbol] \vec{N} [symbol] )^{T}Σ⁻¹(\vec{N}− [symbol] \vec{N} [symbol] ),

where Σ⁻¹ is the inverse covariance matrix of normalized residuals, and vectors in angle brackets denote the mean values of these vectors.

Instead, Kramer-Welch test and/or Wilcoxon test can be used as integral criteria.

At the step (206), imbalances are determined that reflect contributions of test unit (10) operating parameters into said deviation of said test unit operating parameters, i.e. degree of different parameters influence on integral criteria. Residuals, that is differences between the parameter value predicted by a model and the measured value of this parameter, can serve as estimates of system imbalances, while T² test can serve as the integral criterion.

Imbalances are determined using criteria defined at the step (205) and deviations of input test unit parameters from parameters of empirical models for a given period of time.

Let T² is a current value of the Hotelling's test, and T₍ᵢ₎² is the same statistic measure built up for the same variables except for i-th dimension. The measure

dᵢ=T²−T₍ᵢ₎²,

corresponds to contribution of i-th variable to overall statistic measure T². Then the following simple procedure can be performed: each time when a process abnormality signal is generated in course of monitoring the T² value, values dᵢ (i=1, 2, . . . , L) are automatically calculated and the main attention is paid to those variables for which values dᵢ are relatively large, which permits to determine the most significant defects that may arise in the future.

Sequentially removing (filtering off) suspicious variables from the model, analyzing trends of measured variables, and guiding by engineering knowledge of the process, it is in most cases possible to identify a cause of process abnormality or anyhow locate its source.

Further, using said T² criterion, a degree of input test unit parameters deviation from parameters of empirical models for a given period of time can be determined and imbalances for these parameters can be found. A decision on abnormal behavior of received process parameters is made based exclusively on calculated T² criterion, while causes of abnormalities are described by a set of calculated imbalances. Empirical models have statistical nature, and hence it is necessary to detect T² criterion values explicitly exceeding the limit value over a certain time interval (not at certain moments of this interval) in order to conclude that the technical state of the unit has changed.

Based on deviations from reference of both integral T² criterion and main arguments (process parameters) from a localized list, which most greatly contribute to technical state deviation from the reference statistical model, it is possible to identify most critical imbalances in the test unit operation.

Let

x(tⱼ)=[x₁(tⱼ)x₂(tⱼ)x₃(tⱼ) . . . x_{L}(tⱼ)]^{T}

are sampling elements for time moments tⱼ.

Then the state matrix D is determined by the following relationship:

D=[x(t₁)x(t₂)x(t₃) . . . x(t_{M})].

The matrix is composed of the most representative sampling points.

Let x⊗y denotes a similarity operation (being the function of two vectors of process parameters x and y).

Then the “product”

ŵ=(D^{T}⊗D)⁻¹·(D^{T}⊗xᵢₙ),

where symbol ⊗ denotes the similarity operation, can be considered as training set vectors expansion of the measurements vector xᵢₙ, the training set constituting the state matrix. The expanded vector ŵ is thereafter normalized in accordance with Nadaraya-Watson formula:

w=ŵ/Σŵⱼ.

Using vector w, one can obtain an estimate of the “normal” value xₑₛₜ of the measurements vector:

xₑₛₜ=D·w,

which is a projection of the measurements vector xᵢₙ onto the space of “normal” system states given by the matrix D. Therefore, difference of these vectors (residual)

r=xₑₛₜ−xᵢₙ

is an assessment of the system imbalance, i.e. its deviation from the normal state.

The residual for the entire sample is normalized as follows:

ϵᵢ=(rᵢ−r̅ᵢ̅)=σᵢ=[(xᵢₙ_{ᵢ}−xₑₛₜ_{ᵢ})−(̅x̅ᵢ̅ₙ̅_̅{̅ᵢ̅}̅−̅x̅ₑ̅ₛ̅ₜ̅_̅{̅ᵢ̅}̅)̅]/σᵢ,

where σᵢ are standard deviations of residuals for i-th measurement from its mean value.

Let Σ is the covariance matrix for vectors ϵ:

$$Σ = ( \begin{matrix}{σ}_{1}^{2} & {σ}_{12} & … & {σ}_{1 L} \\ {σ}_{21} & {σ}_{2}^{2} & … & {σ}_{2 L} \\ … & … & … & … \\ {σ}_{L 1} & {σ}_{L 2} & … & {σ}_{L}^{2}\end{matrix} ) ,$$

σᵢₖ≡cov(ϵᵢ,ϵₖ)=ϵ̅ₜ̅ϵ̅ₖ̅.

Then

T²=ϵ^{T}Σ⁻¹ϵ.

At the step (207), obtained set of empirical models is used to analyze the input information from the test unit (10) by comparing received test unit (10) parameters with the model parameters over a given period of time.

Further, at the step (208), the reference sample, corresponding to the test unit (10) operating mode and described by the model, is modified by applying filtering and replacing the test unit operating parameters corresponding to the changed technical state of the unit (10) at a given time moment.

At the step (209), the filtered sample is used to update formerly generated one or more empirical models. On the basis of the updated models, deviation in the operation of the test unit (10), in particular, test unit operating parameters, is determined (step (210)).

At the step (211), imbalances obtained at the step (206) are sorted to identify parameters that most greatly contribute to the test unit (10) state change, which allows to select upper imbalances.

Upper imbalances are thereafter used for a more accurate analysis of changes in technical state of the test unit (10) and causes of these changes. Upper imbalances are determined by means of ranking of largest imbalance values. Then dependences of corresponding signals revealed deviations in the test unit (10) operation on time or other signals with largest imbalances are studied.

To automate analysis of emerging problems, detected deviations, measures taken, and obtained results are recorded. Such statistical treatment allows to develop rules of revealing the potentially unreliable parts and components.

To calculate an imbalance j, a matrix, which is pseudo-inverse in relation to the matrix obtained from Σ by zeroing j-th row and column, is used. A similar quadratic form for this pseudo-inverse matrix is calculated and subtracted from T². The result is the j-th imbalance.

Statistical modeling techniques make it possible to calculate a T² limit value for a given confidence level. If the current T² value does not exceed this limit value, a decision is made on adequacy of obtained parameters to behavior of the test unit over the reference time period. On the contrary, if the limit value is exceeded, it is concluded that the obtained set of parameters does not correspond to behavior of the test unit over the reference time period. If it is so, the ranking of imbalances indicates the parameters that most greatly contribute to the test unit technical state change.

The deviations (abnormalities) in the test unit (10) operation detected by SPD&RI at the step (212) are used to form a statistical base, which is further used to analyze defects (213) of technical state of the test unit (10) and subsequently create the digital classifier of defects (214). Below this procedure is described in detail.

An artificial intelligence has been created in SPD&RI (100), which enables to solve the main problem of technical diagnostics, automatic determination of defect nucleation cause and location, in order for early detecting (215) and promptly warning with indication of necessary actions to avoid the loss of the unit (10) functionality.

To solve the problem of detecting process abnormalities in a test unit (10), it is possible to use other nonparametric modeling methods in addition to MSET, for example, kernel regression, kernel smoothing, Support Vector Machine (SVM), fuzzy logic methods, boosting decision trees, principal components, neural networks, and, finally, Similarity Based Modeling (SBM) methods. Results of said additional methods of nonparametric modeling can be verified in the on-line mode against the MSET method results obtained in the off-line mode.

The defect recognition solution (i.e. possible defect classification against known process abnormalities) is based on neural networks. The main problem lies in choosing the most suitable network structure (accuracy, computing power, etc.) for a given unit. It is most preferable to use structures of the multilayer perceptron type or its closest analogues.

SPD&RI (100) has a digital classifier of defects that consists of pairs of input data for each process abnormality, in particular, test unit malfunction parameters, and description of corresponding defect. Physically, the digital classifier of defects is a set of data files for a certain period of time, containing information about significant changes in technical state of unit created by SPD&RI (100).

Additionally, the classifier can be supplemented with expert comments about causes and location of each defect. The digital classifier of defects is used as a training array for the neural network that processes information when monitoring the unit (10) to determine types of incipient defects.

During SPD&RI (100) operation, the digital classifier of defects is constantly updated due to replenishment with new detected significant process abnormalities over a new period of test unit (10) operation time. In addition, the classifier can be supplemented with expert opinions about each defect without filtering the points corresponding to the operating mode described by the model and corresponding to the new technical state of the test unit.

The method of modeling using neural networks is based on the construction of mathematical structures reflecting the organization of neurons and connections between them just as in the nervous system of living beings. Such structure is constituted from elements referred to as neurons, each neuron being characterized by several inputs and one output. Inputs receive signals, which are summed with numerically specified weights. If the sum exceeds a threshold value set up for this neuron, signal “1” is generated at the output, otherwise signal “0”. Said elements are connected to each other in such manner that outputs of some of them are fed to the inputs of one of the similar elements.

A resulting structure can be divided into layers. Input signals are fed to inputs of neurons of the very first layer. Results of the neural network operation are taken from outputs of the last neuron layer. Neural networks differ in number of neurons, structure of their connections, and weights of input signals assigned for each neuron.

The neural network is adjusted, in other words trained, using archived data of the unit operation. The training results in creation of a model of the unit, which installs connections between modeled process parameters and derived parameters referred to as arguments. This procedure adds value to the archived data.

Each input dataset of the neural network corresponds to a set of probabilities related to certain defect types at the output, which is just required to the system for timely detecting onsets of critical events.

When SPD&RI (100) operates in the on-line mode, events of significant process abnormalities (generated by the trigger) are compared against digital “signatures” of abnormalities from a defect classifier created for equipment of given process unit. The system automatically recognizes defects types and predicts state of the test unit (10) in future. An unrecognized process abnormality is automatically recorded in the database, subsequently interpreted by expert, and used for additional training of the neural network.

Data on a detected deviation (defect) and subsequent state of the test unit (10) can be displayed on server as well as transmitted to one or more remote devices of the system users, for example, personal workstation, mobile devices, etc. Besides, an alert trigger can be set up for sending notifications about types of detected defects to respective personal workstations. Each defect type can be linked to a certain personal workstation using the event (defect) type identifier and identifiers of desired workstations, for example, personal accounts, IP addresses, MAC address of devices, telephone numbers, etc.

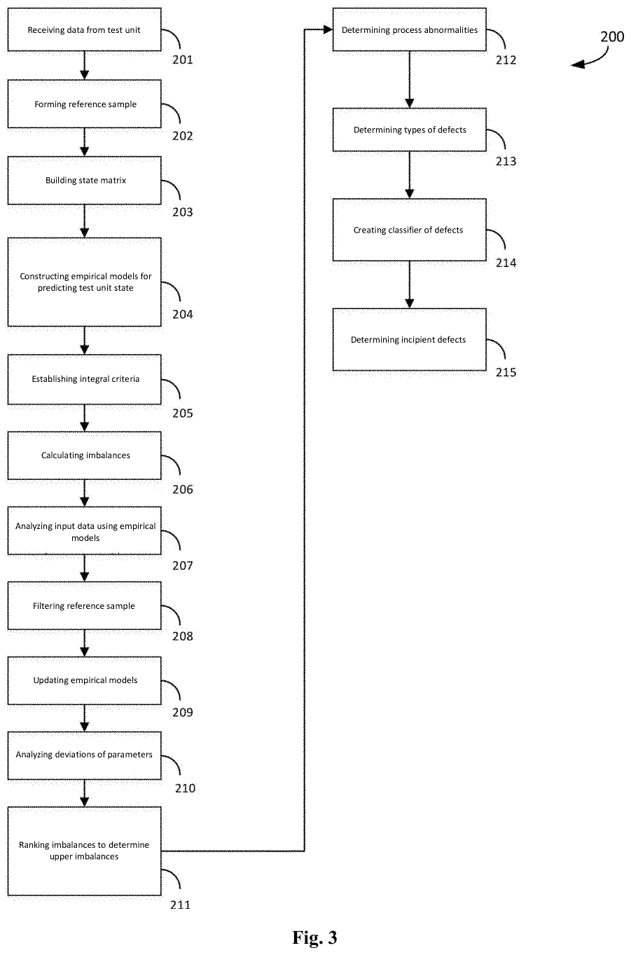

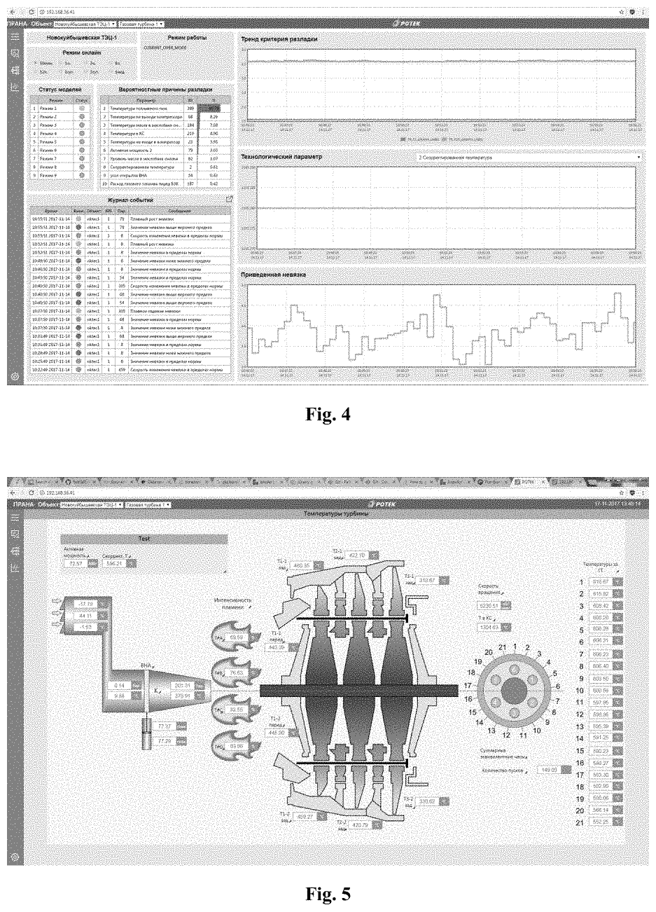

FIGS. 4 and 5 exemplify interface of the SPD&RI (100) used for on-line monitoring with the aim to detect even slightest deviations in operation of the turbine unit well before onset of a critical situation.

Based on the results obtained, notifications are generated for the specialists operating the turbine unit and for service departments, and reports on technical condition over a required period of operation are compiled on regular basis.

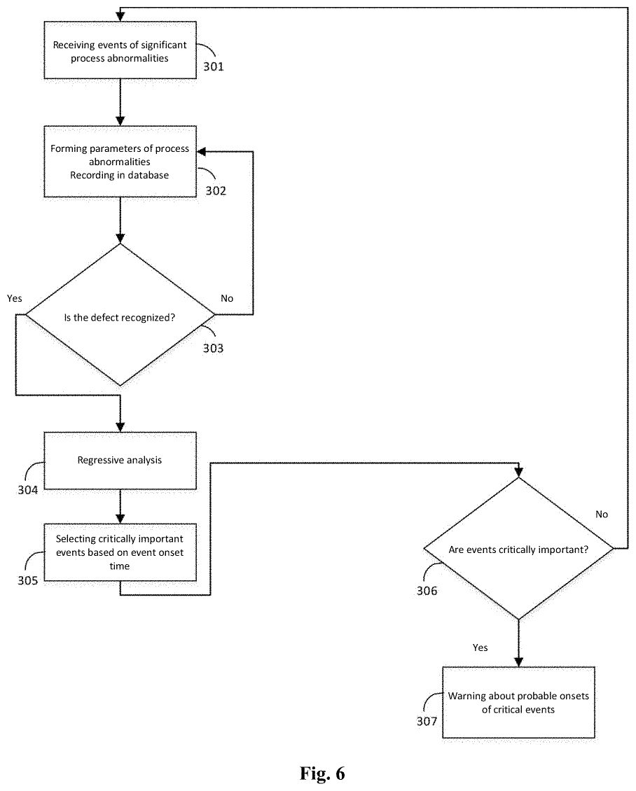

FIG. 6 shows a generalized version of the algorithm for predicting development of an incipient defect when analyzing the further operation of the test unit (10). The analytical processing cycle begins from receiving current parameters values for a significant process abnormality event (301). Process abnormalities are divided onto significant and insignificant. Significant process abnormalities, which are subject to analysis, are characterized by an experimentally established set of integral criteria, imbalances determined at step (211), and residuals in technical state of the test unit (10). Received events (301) of significant process abnormalities in operation of test unit (10) are used to create a file (302) with parameters of said events.

Collected by SPD&RI (100) statistics of significant process abnormalities enables to create a digital classifier of unit's defects in the form of a structured file containing values of said parameters of significant abnormalities (digital signatures) in various operating modes with opinions of experts concerning defects identification.

Significant process abnormality is the deviation of technical state from the reference one such that its empirically determined parameters over a certain time interval Δt values are characterized by:
Exceeding the threshold level of an integral criterion
Imbalances ranked against contributions of arguments to the criterion
Residuals of most significant arguments (with the largest imbalances) exceeding the admissible limits

Then the file created at step (302) is transferred to the neural network trained on the defect classifier to initiate the automatic defect type recognition procedure (step (303)).

It is possible to train the neural network on a digital defect classifier, which is designed as a training array and consists of pairs of significant process abnormalities data and criteria versus descriptions of corresponding defects. The neural network is automatically retrained on newly incoming events of significant process abnormalities being added to digital classifier of defects.

In the on-line mode, a significant process abnormality in an operable technical state is revealed using MSET, its digital signature is formed and directed to input of the trained neural network, which correctly recognizes it and identifies the defect.

If a defect was detected at step (303), then a transition is made to the step (304), where tags of upper imbalances that have made greatest contributions to the integral criterion are subjected to regressive analysis, and thereafter, at step (305), unfavorable or critical event onset time during operation of the test unit (10) and/or its part (component) is estimated upon reaching the specified limit values based on the obtained data. If probability of such event onset was estimated high (306), a corresponding warning is generated (307), otherwise the next cycle of analytical processing (301) begins.

Detected events of significant process abnormalities, integral criteria of these abnormalities, ranked imbalances of arguments, residuals, measured and calculated process parameters are juxtaposed against digital “signatures” (classifiers) of abnormalities from a database created for each unit. Then analytical module of the neural network performs automatic recognition. Finally, the artificial intelligence issues the following information: whether the equipment is functional, partially nonfunctional, or contains an incipient defect; if the last is true, description and location of the defect and time until reaching the warning and emergency alarm levels (residual life).

If a defect remained unrecognized at the step (303), then the unrecognized process abnormality is recorded in the database and supplemented with an expert's comment on the defect causes and location.

Necessary information, in particular, signals on malfunctioning of test unit (10), can be transmitted via public wired or wireless communication networks, for example, Ethernet type LAN, Wi-Fi, GSM, WiMax or MMDS (Multichannel Multipoint Distribution System), etc.

Information from the upper level subsystem (18) of SPD&RI (100) can be transmitted to various remote computer-based devices, for example, IBM PC based AWPs or mobile devices of system users such as smartphones, tablets or laptops, by means of e-mail messages, SMS messages, or push notifications formed by the top level server (180).

SPD&RI (100) also performs analysis of technical state of unit (10) at the user's request by sending a message to the server, which is initiated either by an electronic device (smartphone, laptop), or by setting up for sending regular notifications after a specified period of time (daily, hourly, once a week, etc.), or by reporting on technical state of the unit, or by warning about failure of unit (10) or its certain components.

A test unit (10) can be monitored via a standard web browser and an Internet portal designed to display technical state parameters of the test unit (10). Besides, a real time monitoring of the test unit (10) is possible using a special software application installed on user's device.

Notifications of onset of a critical state or necessity to check some components of the test unit (10) that may cause drop in power of the unit (10) or its failure in the future can be periodically sent to the devices until the server (180) has received a message that the notification has been viewed by the user in response to the sent notifications. This function can be implemented by sending electronic messages after specified period of time or by using a special application or web portal, which, in response to identification of user registered in the notification system of the upper-level server (180), analyzes status of receiving the said notification by the said user. Said status can be associated with the state of the notification parameter on the server, which may have form of record in database with a flag marking that a response message has been received from the user's device.

This description of the claimed invention discloses the preferred embodiments of the claimed solution and should not be construed as limiting any other, particular embodiments beyond the claimed scope of legal protection, which should be understood by a person skilled in the art.

### REFERENCES CITED

1. Gromak E. V., Naumov S. A., Shishov V. A. Remote monitoring system of JSC ROTEK as an element of energy security/New in Russian Electric Power Engineering. 2016. No. 6. P. 36-46.
2. Patent RU 2626780. Method and system for remote monitoring of power plants/Joint Stock Company ROTEK (JSC ROTEK) (RU). Aug. 1, 2016.
3. Scrabatun D. N. Application of PRANA system to assess the technical condition of power equipment. In book: Modern technologies in power engineering: Proc. All-Russian specialized scientific and practical conference of young specialists with international participation, Mar. 30-31, 2017 [To the 130th anniversary since the birth of L. K. Ramzin]/Ed. by S. V. Safronov. Moscow: JSC VTI, 2017. 290 p.
4. Zavaljevski N., Gross K. C. Sensor Fault Detection in Nuclear Power Plants Using Multivariate State Estimation Technique and Support Vector Machines/In book: Proc. Third International Conference of the Yugoslav Nuclear Society, Belgrade, Yugoslavia: Printed in USA by Argonne National Laboratory, 2000, pp. 1-8.
5. Runger G. C., Alt F. B., Montgomery D. C. Contributors to a Multivariate Statistical Process Control Signal/Communications in Statistics. Theory and Methods. 1996. Vol. 25 (10), issue 11, pp. 2203-2213.
6. Yerramareddy et al. Developing empirical models from observational data using artificial neural networks/Journal of Intelligent Manufacturing. 1993. Vol. 4, issue 1, pp. 33-41.
7. Cho et al. Artificial Neural Networks in Manufacturing Processes: Monitoring and Control/IFAC Proceedings Volumes. 1998. Volume 31, issue 15. Pages 529-537.

1. A method for identifying incipient defects in process units, which consists in performing steps of:
receiving data from the test unit that characterize operating parameters of said unit;
forming a reference sample of received unit operating parameters, the said sample corresponding to a continuous operation time interval of the test unit;
building up a state matrix of reference sample parameter values;
building up at least one empirical model for predicting state of the test unit, which represents the unit's state in a multidimensional space of unit parameters;
defining integral criteria that characterize deviations of the test unit's parameters;
determining imbalances that reflect degree of unit operating parameters influence on said deviations of the test unit operating parameters;
analyzing the input information from the test unit using the obtained set of empirical models by comparing the received test unit parameters with the model parameters within a given time interval;
modifying the reference sample by replenishing it with points collected within the new time period and filtering points corresponding to the mode of operation described by the model and corresponding to a new functional state of the test unit;
updating pre-built empirical models based on the filtered sample;
determining degree of input test unit parameters deviation from parameters of empirical models for a given period of time based on said integral criteria and revealing imbalances for these parameters;
sorting calculated imbalances to determine upper imbalances, which represent the parameters that most strongly contribute to the test unit state change;
identifying at least one significant process abnormality in at least one test unit parameter based on certain integral criteria and upper imbalances;
identifying type of defect in the test unit for each significant process abnormality;
compiling a digital classifier of defects in the unit based on identified significant process abnormalities, containing identified parameters of process abnormalities in various operating modes of the test unit;
identifying at least one incipient defect is determined and predicting its development by means of processing input information from the test unit by a neural network trained on the generated digital classifiers.

2. A method according to claim 1, wherein empirical models are created using a method selected from the group comprising: MSET (Multivariate State Estimation Technique), Kernel Regression, Kernel Smoothing, Support Vector Machine (SVM), Similarity Based Modeling (SBM), neural networks, fuzzy logic, principal components, or boosting decision trees.

3. A method according to claim 2, wherein said empirical models are statistical and dynamic models.

4. A method according to claim 1, wherein said empirical models are created for a plurality of different modes of test unit operation.

5. A method according to claim 1, wherein an empirical model corresponding to a given mode of test unit operation is automatically switched into another model corresponding to new mode of test unit operation when the mode of operation is changed.

6. A method according to claim 1, wherein training samples of significant process abnormalities are generated for neural network by the prognostics and remote monitoring system itself.

7. A method according to claim 1, wherein a digital classifier of defects, in a particular embodiment of the invention, is a set of pairs of significant process abnormalities data and descriptions of corresponding defects.

8. A method according to claim 1, wherein significant process abnormalities are determined in on-line mode using nonparametric modeling methods.

9. A method according to claim 1, wherein the integral criterion is selected from the group consisting of Hotelling's criterion, Kremer's criterion, and Wilcoxon's criterion.

10. A system for identifying incipient defects in process units comprising at least one processor and memory means that contain machine-readable instructions, which, if being executed by said processor, implement a method for identifying incipient defects in process units according to claim 1.

11. A system according to claim 10, comprising at least one personal workstation designed to receive the notification on identification of an incipient defect in a test unit and/or its component.

12. A system according to claim 11, wherein the notification additionally contains information about residual resource of the test unit and/or its component.

13. A system according to claim 11, wherein the personal workstation is selected from the group comprising a personal computer, laptop, tablet, smartphone, or thin client.

14. A system according to claim 11, wherein the notification is transmitted via wired and/or wireless communication means.

15. A system according to claim 11, wherein the notification is sent to the corresponding personal workstation depending on type of defect.
